(19) United States
(12) Patent Application Publication
(10) Pub. No.: US 2021/0047212 A1
(43) Pub. Date: Feb. 18, 2021

(54) LIQUID PURIFIER

(71) Applicant: Jose Ramón CAMPOS CASTILLO, Alicante (ES)

(72) Inventor: Jose Ramón CAMPOS CASTILLO, Alicante (ES)

(21) Appl. No.: 16/966,889

(22) PCT Filed: Jan. 29, 2019
(86) PCT No.: PCT/ES2019/070049

§ 371 Date: Aug. 1, 2020

(30) Foreign Application Priority Data
Feb. 1, 2018 (ES) U 201830130

(51) Int. Cl. C02F 1/78

(52) U.S. Cl. CPC C02F 1/78; C02F 2307/04; C02F 2201/008; C02F 2201/782

(57) ABSTRACT

The present invention relates to a portable liquid purifier for purifying liquid contained in the purifier using an ozone flow that passes through the liquid. The invention comprises a container, an ozone generator built into the base of the container, a blower extending from the ozone generator and provided with blow holes in the lower part of the container, and a standalone power source that does not have to be connected to the network during the operation of the purifier in order to power the ozone generator and the blower. The invention can be used to purify drinks in any location, while camping, hiking, travelling in exotic countries, etc., owing to the bactericidal, viricidal, and fungicidal properties of the ozone, as well as offering the unexpected or additional advantage of performing disinfection in the same container into which the ozone generator is built.

### OBJECT OF THE INVENTION

The present invention relates to a liquid purifier that can be used for example to disinfect any beverage before consumption.

### BACKGROUND OF THE INVENTION

Drink intake may not always be healthy, especially when they do not come from plants with guarantees or from water sources from networks with means of disinfection, such as urban drinking water networks. This is sometimes not possible, for example, if during outdoor activities, such as camping or hiking, you want to drink water from a natural channel, or on tourism trips to exotic countries where the health of water supply networks does not It is guaranteed or at least not very effective.

In addition to the above, there are people who prefer to disinfect water regardless of its origin. The disinfection can be carried out by means of water purification tablets, normally with high chlorine contents, with the disadvantage that an improper or prolonged use can cause health problems and provides unpleasant flavors.

These drawbacks are solved by using the liquid purifier of the invention.

### DESCRIPTION OF THE INVENTION

The liquid purifier of the invention has a configuration that allows a portable use thereof and its use in any location, carrying out the purification of the liquid by means of an ozone flow through it. According to the invention, the purifier comprises:
a container,
an ozone generator integrated in the base of the vessel,
a blower arranged next to the ozone generator and provided with blower outlets at the bottom of said container, and
a stand-alone power supply (which does not need to be connected to the network during operation of the purifier) for the ozone generator and for the blower.

This allows the purification of beverages in any location, camping, hiking, trips to exotic countries, etc., finding as an additional or unexpected advantage the disinfection in the same container in which the ozone generator is integrated, getting a Fully portable and compact purifier. This is due to the bactericidal, viricidal and fungicidal properties of ozone, which is therefore a potent disinfectant and a highly effective antiseptic, rapidly destroying streptococci, staphylococci, colibacils and other bacteria, as well as the most energetic diphtheria and tetanus toxins.

The microbicidal action (against bacteria, viruses, fungi or spores) is the most important property of ozone. Since the most common contaminants in beverages fall into this category, the effectiveness is complete.

The bactericidal effect is evident at low concentrations (0.01 p.p.m. or less), and during very short periods of exposure a bacteriostatic effect is already perfectly observable, preventing the reproduction of bacteria.

The viricidal effect of ozone oxidizes the envelope proteins of viruses by modifying their three-dimensional structure. When this happens, the virus cannot bind to any host cell because it does not recognize its anchor point, and being found unprotected cannot reproduce and dies.

The fungicidal and sporicidal effect of ozone is very important, since it is capable of eliminating them even in a latent state, since it creates conditions in the environment such that spores and fungi are radically eliminated. In addition, it has other beneficial effects, such as:
Eliminates mites and allergies associated with them, and
Eliminates odors/flavors.

### BRIEF DESCRIPTION OF THE DRAWINGS

FIG. 1 shows an elevation view of the liquid purifier of the invention.

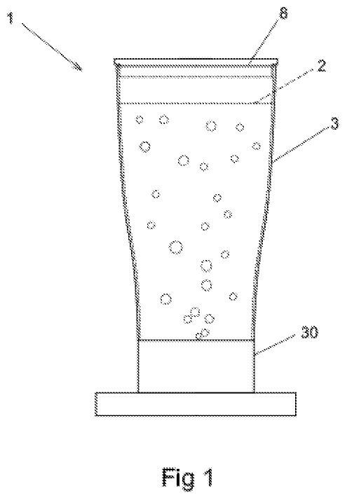

FIG. 2 shows a section of the liquid purifier of the invention according to the view of FIG. 1.

### DESCRIPTION OF A PRACTICAL EMBODIMENT OF THE INVENTION

The liquid purifier (1) of the invention comprises:
a container (3),
an ozone generator (4) integrated in the base (30) of the container (3),
a blower (5) arranged next to the ozone generator (4) and provided with blower outlets (50) in the lower part of said container (3), and
a stand-alone power supply (6) for the ozone generator (4) and for the blower (5).

Very preferably, the container (3) has a width less than its height to favor the flow of ozone through the entire volume of liquids with less power consumption of the blower (5) and thus prolong the life of the power supply, while the blow outings (50) or the possible ducts (55) that feed them will incorporate non-return valves (56) to allow the gas to escape due to overpressure, but preventing the liquid from leaking out of them when it is not being produced blowing, preventing the container (3) from emptying.

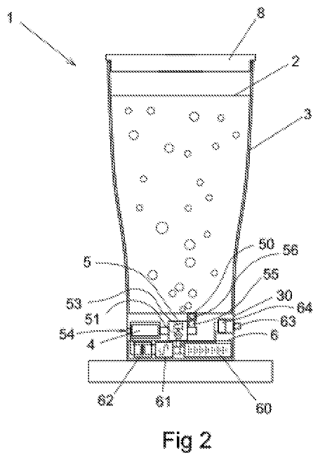

Specifically, the autonomous power supply (6) comprises a portable battery (60) (ideally rechargeable). These types of batteries provide direct current power and with a low potential, so in addition, the power supply will have an oscillator (61) (understanding as such any electrical or electronic assembly capable of obtaining a variable current flow from the direct current supplied by the source of supply, and a voltage booster (62), ideally a transformer, so that we obtain a variable voltage current high enough to feed a conventional ozone generator (4), for example one comprising a corona effect generator. The simplest oscillator (61) could be a resonant oscillator or an inverter, for example. The base (30) will be ideally practicable to be able to access for replacement, assembly or repair to any of the elements housed therein. As for the blower (5), it ideally comprises a small turbine (53) coupled to a motor (51) fed by the autonomous power supply (6) to force an air flow through the ozone generator (4) towards the outlets blowing (50). This creates an upward flow through the volume of liquid that performs the disinfection. FIG. 2 shows the interior elements of the purifier (1), including an obvious switch (63) for activation of the operation. In addition, you can incorporate a timer (64) or programmer to cause the disconnection after a while, or even to program an on and off cycle. Also, an outside air intake (54) for air intake for generation of the air flow that will pass through the ozone generator (4).

Finally, indicate that the container (3) ideally comprises a lid (8) to improve the ozone concentration during disinfection, as well as to preserve and protect the contained liquid. Sufficiently described the nature of the invention, as well as the manner in which it is carried out in practice, it should be noted that the provisions indicated above and represented in the attached drawings are subject to modifications in detail as long as they do not alter the fundamental principle.

1. A purifier of liquids comprising:
a container,
an ozone generator integrated in base of the container,
a blower arranged next to the ozone generator comprising blower outlets in lower part of said container, and
a stand-alone power supply for the ozone generator and the blower.

2. The purifier of liquids of claim 1, wherein the width of the container is less than its height.

3. The purifier of liquids claim 1, wherein the blower outlets or ducts that feed said outlets comprise non-return valves.

4. The purifier of liquids of claim 1, wherein the autonomous power supply further comprises a portable direct current battery, an oscillator and a voltage booster.

5. The purifier of liquids claim 1, wherein the ozone generator further comprises a corona effect generator.

6. The purifier of liquids claim 1, wherein the blower comprises a turbine coupled to a motor fed by the autonomous power supply to force an air flow through the ozone generator to the blow outings.

7. The purifier of liquids claim 1, further comprising a timer.

8. The purifier of liquids claim 1, wherein the container further comprises a lid.

9. The purifier of liquids of claim 1, further comprises an operating program.

10. The purifier of liquids of claim 6, wherein the air flow is generated through an outside air intake.
